(19) United States
(12) Patent Application Publication
(10) Pub. No.: US 2012/0153791 A1
(43) Pub. Date: Jun. 21, 2012

(54) Drop Front Locking Device and Hinge

(75) Inventor: John M. Green, East Otto, NY (US)

(73) Assignee: Bush Industries, Inc., Jamestown, NY (US)

(21) Appl. No.: 12/970,301

(22) Filed: Dec. 16, 2010

(51) Int. Cl. A47B 88/18; F16B 2/20

(52) U.S. Cl. 312/333; 24/457

(57) ABSTRACT

A clip system having a post for use with a drawer, such as a drawer used to support a computer keyboard, wherein the drawer includes a hingedly attached drop down front member that can pivot to an open or horizontal position to allow access to the keyboard. The locking device holds the front member in a vertical or closed position to prevent an inadvertent release thereof so that the drawer can function as a conventional desk drawer. The clip system includes a clip secured to the front member and a post secured to the bottom of the drawer. The clip and post cooperate together to hold the front member in the vertical position. A locking pin is provided which cooperates with the post and the clip for locking the front member in the vertical/closed position to prevent the inadvertent release and drop down of the front member.

### BACKGROUND OF THE INVENTION

### Field of the Invention

The invention relates generally to a drop front locking device and hinge for a drawer, such as a keyboard drawer and, more particularly, directed to a clip system including a removable locking pin for locking the drawer in a closed position to prevent any unintentional drop down of a front face of the drawer.

A typical keyboard drawer, in which a keyboard may rest, includes a front face hingedly connected to a bottom surface of the drawer allowing the front face of the drawer to be lowered to provide access to the keyboard or raised to provide the appearance of a conventional desk drawer.

A holding member is typically provided to hold the front face in a vertical or closed position. This holding member is released to allow the front face to drop down to an open or horizontal position. These members are often expensive to produce and include a number of independently working components.

FIG. 1 shows an example of a clip system, generally indicated as 112, that can be used to hold the front member of a keyboard drawer (not shown) in the vertical or closed position. The clip system 112 includes a clip 120 having a pair of resilient arms 130. Typically, the clip 120 is secured to the front member of the keyboard drawer. A post 134 is provided which can be secured to a bottom member of the keyboard drawer. When the front member is in the closed or vertical position, the post 134 is received and held by the pair of resilient arms 130. Since the post 134 is held solely by the resilient arms 130, these types of clip systems can unintentionally release so that the front member drops down, especially upon the application of an abrupt pulling force to the drawer.

### SUMMARY OF THE INVENTION

According to a first aspect, the invention is directed to a clip system having a locking device for use with a drawer, such as a drawer used to support a computer keyboard, wherein the drawer includes a bottom member and a front face moveable between a vertical or closed position and a horizontal position. A locking pin holds the front face in the vertical or closed position enabling the drawer to be used as a conventional desk drawer. The clip system includes a hinge adapted for pivotably connecting the bottom member to the front face so that the front face is pivotable about the hinge between the vertical or closed position and the horizontal or open position. When the front face is in the closed and locked position the drawer functions as a typical desk drawer. When the front face is in the open or horizontal position, one can access the computer keyboard. The device includes a clip associated with the front face, a post associated with the clip wherein the post is configured for being secured to the bottom member of the drawer, and a locking pin configured for cooperation with the post and the clip for locking the front face in the vertical or closed position. The locking pin prevents the unintentional release of the front face from the vertical position. The clip can include a pair of opposed resilient aims and the post can comprise a longitudinal member configured for extending through the resilient arms. This longitudinal member can have a wing portion at one end and this wing portion has at least a first wing aperture extending therein. The clip can have a clip aperture extending therein such that when the front face of the drawer is in the closed position and the post is received within the opposed resilient arms of the clip, the first wing aperture and the clip aperture are aligned to receive the locking pin. The device can include a fastener and binding barrel arrangement for cooperating with the longitudinal member of the post for securing the post to the bottom member of the drawer. According to one embodiment, the wing portion can include at least a second aperture for storing the locking pin when the device is in an unlocked position. The bottom member has a top surface and a bottom surface and the clip and the post can be located adjacent to the top surface.

According to another aspect, the invention is directed to a front face drop down drawer comprising a bottom member, a front face, and a hinge for hingedly connecting the front face to the bottom member wherein the front face is movable, with respect to the bottom member, between a vertical position and a horizontal position. A clip is associated with the front face and a locking device is associated with the bottom member. The clip and the locking device are configured for cooperating together to lock the front face in the vertical position with respect to the bottom member and for preventing the unintentional release of the front face and movement of this front face to the horizontal position. A removable lock pin can be provided which is configured for cooperating with the locking device and the clip for locking the front face in the vertical position. This lock pin can be removable from at least the clip to unlock the front face so that the front face can be moved to the horizontal position. The locking device can include a wing and a wing aperture and the clip can include a clip aperture which is adapted for alignment with the wing aperture. The lock pin cooperates with the wing aperture and the clip aperture when in an aligned position to lock the front face in the vertical position. The bottom member of the drawer has a top surface and a bottom surface and the clip and the locking device are located adjacent to this top surface and the hinge is located adjacent to this bottom surface. The clip can be secured to the front face and the locking device can be secured to the bottom member with a fastener and binding barrel arrangement that extends through an aperture in the bottom surface to secure the locking device to the bottom surface.

According to yet another aspect, the invention is directed to a clip system for securing a hinged front face or drawer panel in a closed upright position wherein the front drawer panel is pivotably attached to a bottom member or drawer panel and is pivotable between a horizontal open position and the closed position. The clip system comprises a post adapted to be secured to the bottom drawer panel, a resilient clip secured to the front drawer panel and adapted to resiliently engage the post to hold the front drawer panel in the upright position, and a locking pin configured to cooperate with the post and the resilient clip to lock the front drawer panel in the upright position and prevent unintentional pivoting of the front drawer panel to the open position. The post can comprise a longitudinal member having a wing portion at one end. This wing portion can have at least a first wing aperture therein and the clip can have a clip aperture extending therein such that in the closed position, the wing aperture and the post aperture align to receive the locking pin. The wing portion can include at least a second aperture for storing the locking pin when the device is in an unlocked position. The system can also include a fastener and a binding barrel, both of which extend through an aperture in the bottom drawer panel for securing the post to the bottom drawer panel.

These and other features and characteristics of the present invention, as well as the methods of operation and functions of the related elements of structures, and the combination of parts and economies of manufacture will become more apparent upon consideration of the following description with reference to the accompanying drawings, all of which form a part of this specification, wherein like reference numerals designate corresponding parts in the various figures.

### BRIEF DESCRIPTION OF THE DRAWINGS

FIG. 1 shows a perspective view of a clip system according to the prior art;

FIG. 2 shows a perspective view of a drawer including a pair of the clip systems according to the present invention where the clip systems are in the locked position and the front face is in a vertical position;

FIG. 3 shows a close-up perspective view of one of the clip systems of FIG. 2 in the locked position;

FIG. 4 shows a close-up perspective view of one of the clip systems in the unlocked position;

FIG. 5 shows a cross-sectional side view of the clip system and drawer of FIG. 3;

FIG. 6 shows an exploded view of the clip system according to the invention;

FIG. 7A shows front side perspective view of a portion of the clip according to the invention;

FIG. 7B shows a back side perspective view of the clip according to the invention;

FIG. 8 shows a perspective view of a drawer including a pair of clip systems according to the present invention where the clip systems are in the unlocked position and the front face of the drawer is in a horizontal position; and

FIG. 9 shows a side view of the clip system and drawer of FIG. 8.

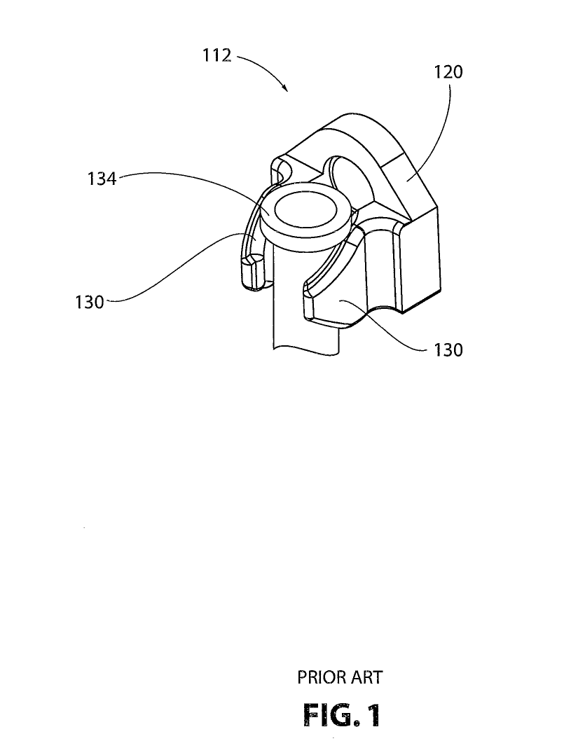

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

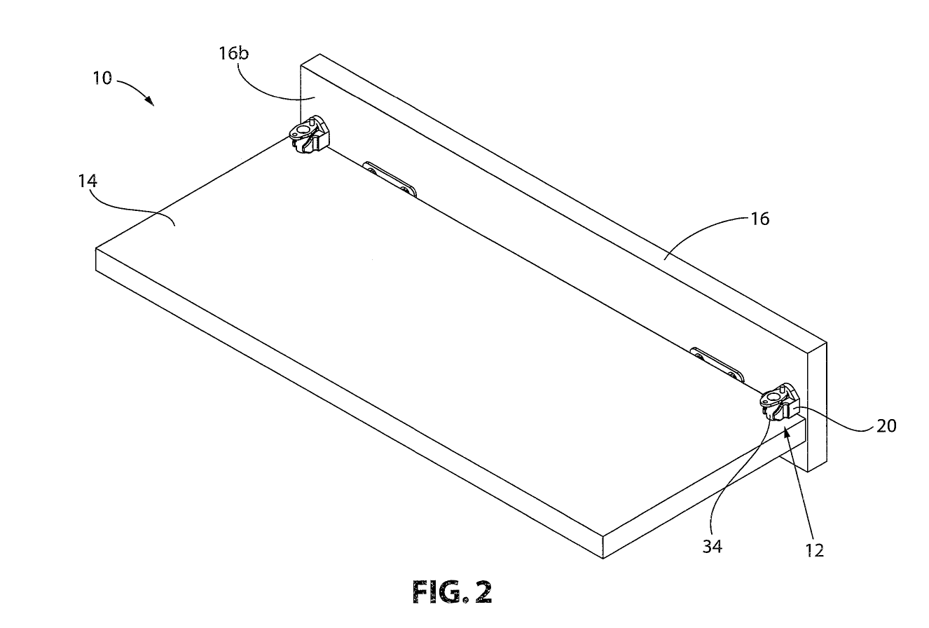

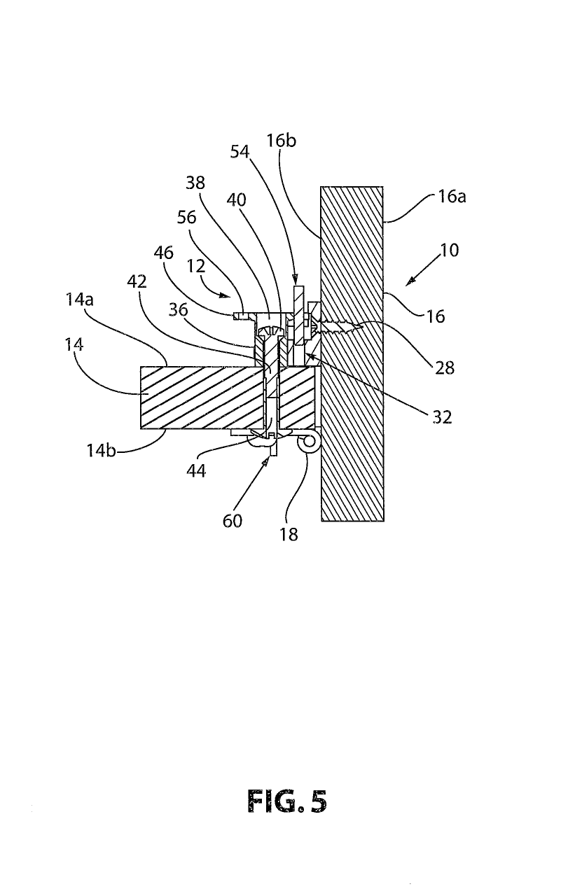

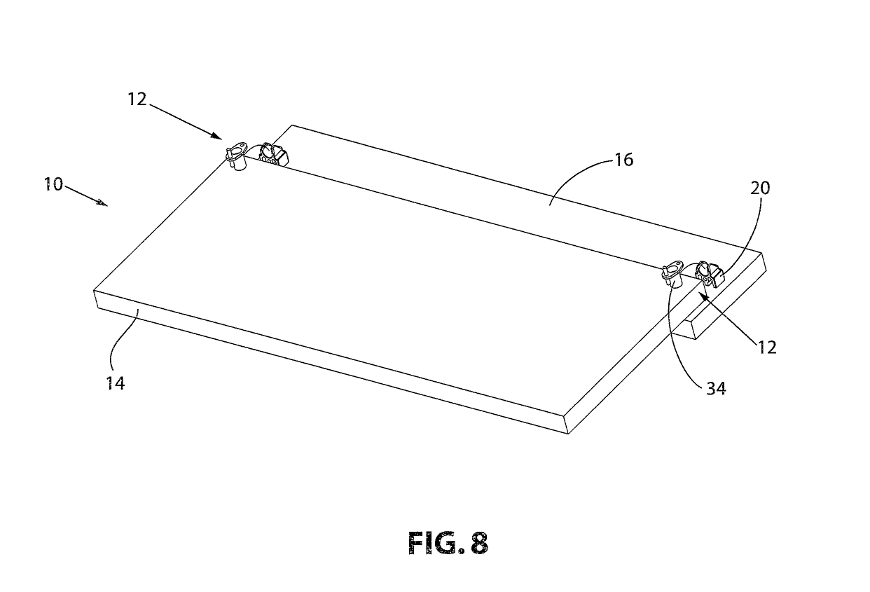

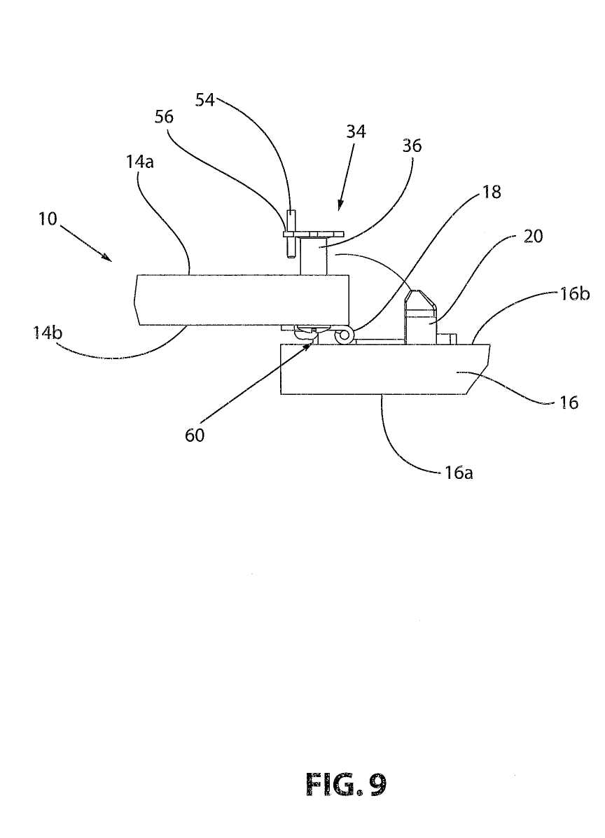

Reference is now made to FIGS. 2-5 and FIGS. 8-9 which show a drawer 10 including the clip system, generally indicated as 12, according to the present invention. The clip system 12 can be used, for example with a drawer 10 used, for example to support a computer keyboard. The drawer 10 includes a bottom drawer panel or bottom member 14 and a front drawer panel or front member 16 which is movable from a vertical position, as shown in FIGS. 2-5 to a horizontal position, as shown in FIGS. 8-9. As illustrated in FIG. 5, the bottom member 14 includes a top surface 14a and a bottom surface 14b and the front member 16 includes a front surface 16a and a back surface 16b.

As further illustrated in FIG. 5, the clip system 12 includes a hinge 18 adapted for pivotably connecting the bottom member 14 to the front member 16 so that the front member 16 is pivotable about the hinge 18 between the vertical or closed position (FIGS. 2-5) and the horizontal or open position (FIGS. 8-9). When the front member 16 is in the closed position the drawer 10 functions as a conventional desk drawer. When the front member 16 is in the open or horizontal position, the drawer 12 functions as a computer keyboard support surface and one can access the keyboard (not shown) for use with a computer.

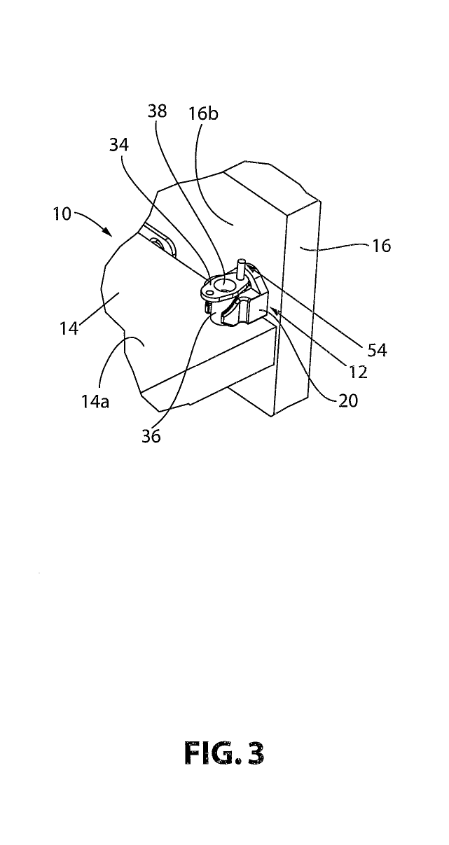

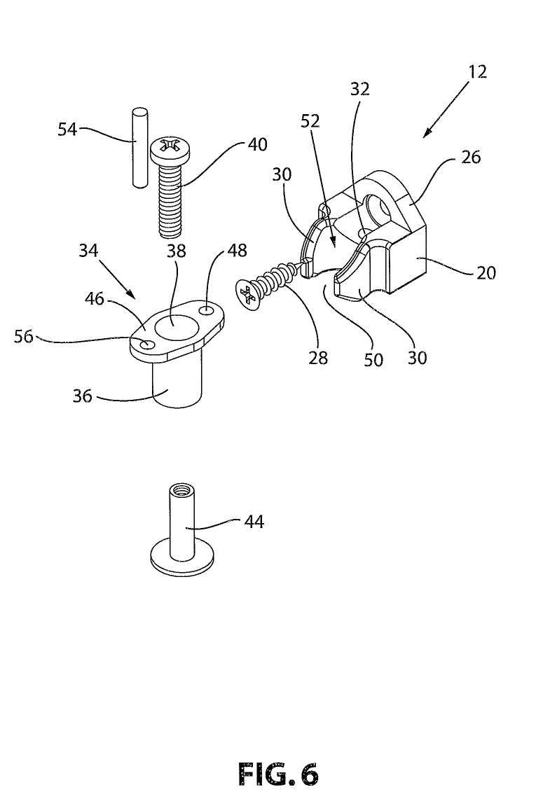

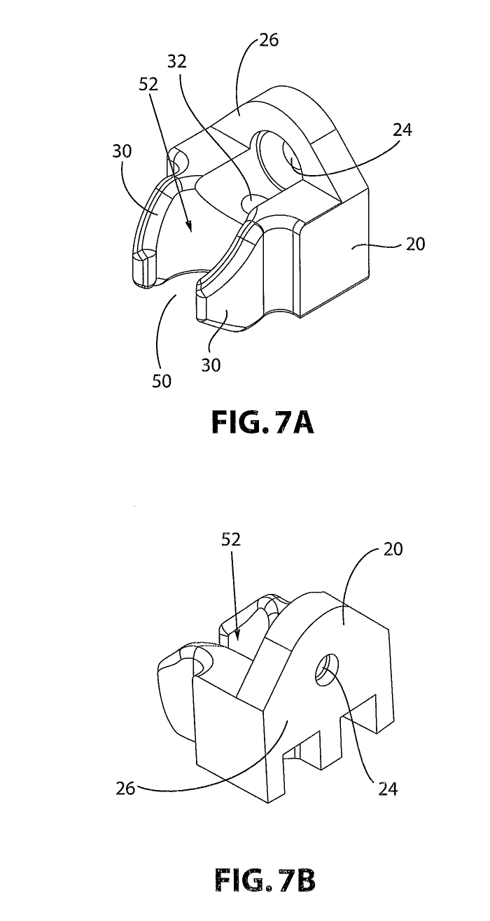

Referring now to FIGS. 3, 5, 7A and 7B, the system includes a clip 20, which is configured to be secured to a back a surface 16b of the front member 16. The clip 20 can be secured through an aperture 24 extending through a back portion 26 of the clip 20, as shown in FIG. 6B. As illustrated in FIGS. 5-6, a fastening member 28, such as a screw, nail, and the like, can be used to secure the clip 20 to the back surface 16b of the front member 16. As best shown in FIG. 7A, the clip 20 includes a pair of opposed resilient arms 30 which curve toward one another to leave an opening 50 at a front position of the clip 20. These resilient arms 30 also define an open portion, generally indicated as 52. The clip 20, with the arms 30, can be formed from a resilient material such as nylon or any other well known resilient material which allows for the opposed resilient arms 30 to flex a sufficient amount to receive a locking device or post 34 (FIG. 3) through opening 50 and hold post 34 in open portion 52, as discussed below.

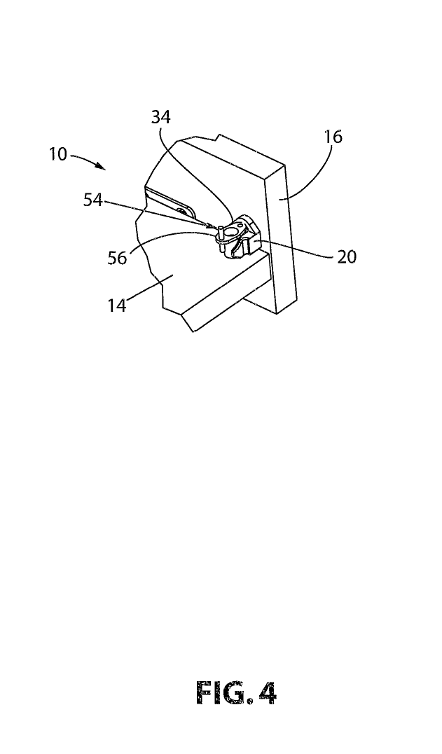

The post 34, into which the clip 20 engages, is configured for being secured to the bottom member 14 of the drawer 10. Directing attention to FIGS. 5 and 6, the post 34 may be a longitudinal member 36, and is configured for being received within and extending through the opposed resilient arms 30 of the clip 20 when the front face 16 of the drawer 10 is in the vertical or closed position. The longitudinal member 36 can be a tubular member including an opening 38. The longitudinal member 36 is positioned adjacent to the top surface 14a of the bottom member such that the opening 38 of the longitudinal member 14 is aligned with an aperture 42, as best shown in FIG. 4, extending through the bottom member 14. A binding member 44, such as an elongated nut, as best shown in FIGS. 5 and 6, can extend up through the bottom surface 14b of the bottom member 14 to cooperate with a fastener 40 to secure the post 34 to the bottom member 14. Other fasteners may include screws, nails or the like.

Referring back to FIG. 6, the post 34 includes a wing portion 46 at one end and this wing portion 46 has at least a first wing aperture 48 extending therethrough. The clip 20 includes the clip aperture 32 extending therein. When the front face 16 of the drawer 10 is in the vertical or closed position and the post 34 is received within the open portion 52 defined by the opposed resilient arms 30 of the clip 20, the first wing aperture 48 and the clip aperture 32 become aligned.

The clip system 12 further includes a locking pin 54. As illustrated in FIGS. 2-6, the aligned first wing aperture 48 and the clip aperture 32 can receive the locking pin 54 to lock the post 34 to the clip 20, thereby securing the front member 16 in the vertical or closed position. The locking pin 54 provides a rigid connection between the clip 20 and post 34 and prevents the inadvertent release of the front member 16 from this vertical or closed position, especially upon the application of an abrupt outward pulling force of the drawer 10, such as when the drawer 10 is functioning as a typical drawer in a desk and the user has no desire or expectation for the front member 16 to flip to the open position. When is it desired to use the drawer 10 as a keyboard drawer for use with a computer, as illustrated in FIGS. 8-9, the locking pin 54 can be removed from the aligned first wing aperture 48 and from the clip aperture 32 to unlock the post 34 from the clip 20 and upon the application of a force to the front member 16 to allow the opposed resilient arms 30. This application of force causes the opposed resilient arm 30 of the clip 20 to expand the arms 30 to separate from the post 34 and release the post 34, whereby the front member 16 pivots and drops down to a horizontal or open position. A hinge stabilizer 60, as shown in FIGS. 5 and 9, can be provided to add support when the front member 16 is dropped down and to prevent over rotation of the front member 16 and stress onto the hinge 18.

The post 34, fasteners 28, 40, binding member 44 and locking pin 54 can be formed from any well-known load bearing material, such as stainless steel or any other type of load bearing material.

Referring still to FIGS. 6 and 8-9, according to one embodiment, the wing portion 46 can include at least a second aperture 56 for storing the locking pin 54 when the clip system 12 is in the unlocked position. Alternatively, the locking pin 54 can be stored at a separate location, such as in the desk, and/or attached to a key chain, lanyard, and the like.

Although the invention has been described in detail for the purpose of illustration based on what is currently considered to be the most practical and preferred embodiments, it is to be understood that such detail is solely for that purpose and that the invention is not limited to the disclosed embodiments, but on the contrary, is intended to cover modifications and equivalent arrangements that are within the spirit and scope of the invention. For example, it is to be understood that the present invention contemplates that, to the extent possible, one or more features of any embodiment can be combined with one or more features of any other embodiment.

The invention claimed is:

1. A clip system for use with a drawer, wherein the drawer includes a front member moveable between a vertical position and a horizontal position and a bottom member, the clip system comprising:
a) a hinge adapted for connecting the bottom member to the front member wherein said front member is movable about the hinge between the vertical and horizontal positions with respect to the bottom member;
b) a clip associated with the front member;
c) a post associated with the clip, said post configured for being secured to the bottom member of the drawer and sized to resiliently engage the clip; and
d) a locking pin configured for cooperation with said post and said clip to rigidly engage and lock the clip to the post with the front member in the vertical position.

2. The clip system of claim 1, wherein the clip comprises a pair of opposed resilient arms.

3. The clip system of claim 2, wherein the post comprises a longitudinal member configured for extending through the resilient arms, said longitudinal member having a wing portion at one end wherein the wing portion has at least a first wing aperture extending therein and wherein the clip has a clip aperture extending therein such that when the front member is in the vertical position, the first wing aperture and the clip aperture align to receive the locking pin.

4. The clip system of claim 2, including a fastener for cooperating with the longitudinal member of the post for securing the post to the bottom member of the drawer.

5. The clip system of claim 4, including a binding member for cooperating with the fastener.

6. The clip system of claim 3, wherein the wing portion includes at least a second aperture for storing the locking pin when the clip system is in an unlocked position.

7. The clip system of claim 1, wherein the bottom member has a top surface and a bottom surface and wherein the clip and the post are located adjacent to the top surface of the bottom member.

8. A front face drop down drawer comprising:
a) a bottom member, a front member, and a hinge for hingedly connecting the front member to the bottom member, said front member movable between a vertical position and a horizontal position with respect to the bottom member;
b) a clip associated with the front member;
c) a post associated with the bottom member, said clip and said post configured for cooperating together to hold said front member in the vertical position with respect to the bottom member; and
d) a removable locking pin configured for cooperating with the post and the clip for locking the front member in the vertical position and for preventing inadvertent release of the front member and movement to the horizontal position, said locking pin being removable from at least the clip to unlock the front member so that it may be moved to the horizontal position.

9. The drawer of claim 8, wherein the post includes a wing and a wing aperture and the clip includes a clip aperture which is adapted for alignment with the wing aperture and wherein the locking pin cooperates with the wing aperture and the clip aperture when in an aligned position to lock the front member in the vertical position.

10. The drawer of claim 8, wherein the bottom member has a top surface and a bottom surface and wherein when the front member is in the vertical position, the clip and the post are located adjacent to the top surface and the hinge is located adjacent to the bottom surface.

11. The drawer of claim 8, wherein the clip is secured to the front member and the post is secured to the bottom member.

12. The drawer of claim 10, wherein the post cooperates with a fastener and a binding member and wherein the fastener and binding member extend through an aperture in the bottom surface to secure the post to the bottom member.

13. A clip system for securing a hinged front drawer panel in a closed upright position, wherein the front drawer panel is pivotably attached to the bottom drawer panel and is pivotable between a horizontal open position and the closed position, wherein the clip system comprises:
a post adapted to be secured to the bottom drawer panel;
a clip secured to the front drawer panel and adapted to resiliently engage the post to hold the front drawer panel in the upright position; and
a locking pin configured to cooperate with the post and the clip to lock the front drawer panel in the upright position and prevent inadvertent pivoting of the front drawer panel to the open position.

14. The system of claim 13, wherein the post comprises a longitudinal member having a wing portion at one end, wherein the wing portion has at least a first wing aperture therein and wherein the clip has a clip aperture extending therein such that in the closed position, the wing aperture and the post aperture align to receive the locking pin.

15. The system of claim 14, wherein the wing portion includes at least a second aperture for storing the locking pin when the device is in an unlocked position.

16. The system of claim 13 including a fastener and a binding member extending through an aperture in the bottom drawer panel for securing the post to the bottom drawer panel.

17. The system of claim 13 wherein at least a portion of the clip is formed from a resilient material.
